(19) United States
(12) Patent Application Publication
(10) Pub. No.: US 2007/0238433 A1
(43) Pub. Date: Oct. 11, 2007

(54) Circuit and method for clock correction in telecommunication system

(75) Inventor: Takeshi Ichikawa, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD.

(21) Appl. No.: 11/708,002

(22) Filed: Feb. 20, 2007

(30) Foreign Application Priority Data
Mar. 8, 2006 (JP) 2006-062939

(51) Int. Cl. H04B 1/06

(52) U.S. Cl. 455/255

(57) ABSTRACT

Disclosed are a low-cost circuit, a communication apparatus and a method for correcting a clock and for application to a specific radio system with low electric power consumption. The communication apparatus comprises: a frequency data storage circuit for storing frequency set values corresponding to respective channels to output a frequency set value corresponding to a channel specified by a channel selection signal; a frequency correction circuit for calculating a frequency control value by performing a calculation using both the frequency control value and a frequency correction value determined in accordance with an ambient temperature; a voltage controlled oscillator for generating a first frequency based on a clock signal; and a PLL circuit for generating a desired second frequency by performing a calculation using the first frequency and the frequency control value.

### BACKGROUND OF THE INVENTION

1. Field of the Invention

The present invention relates to a telecommunication system, and more particularly, to clock correction technique for the telecommunication system.

2. Description of the Related Art

Transceivers for use in radio communication systems have employed expensive reference clock generators which are configured to generate a reference clock having a center frequency in conformity with a standard specification without substantial temperature dependency corrections. Patent Document 1 (Japanese Patent Application Kokai No. Hei5-102955) discloses a digital modulator circuit which eliminates the need for employing an expensive reference oscillator.

The digital modulator circuit disclosed in Patent Document 1 has a memory circuit that stores frequency correction data, and controls a voltage-controlled oscillator to prevent changes in frequency with passage of time. This digital modulator circuit can be used for a communications system, such as an automobile telephone, that is capable of operating over a long period of time and uses two types of clocks: a high-frequency clock and a low-frequency clock. This digital modulator circuit detects a frequency shift of the low frequency clock to correct for the frequency shift, while maintaining accuracy in the range of higher harmonics. This digital modulator circuit, then, does not correct the high-frequency clock for its frequency shift. Accordingly, the problem is that this digital modulator circuit, as in a specific radio system with low electric power consumption, cannot be used when a communication time is relatively short and the tolerance range of the frequency shift is large for data transfer rates between base stations.

### SUMMARY OF THE INVENTION

In view of the foregoing, it is an object of the present invention to provide a low-cost circuit, mobile terminal, base station apparatus and method for correcting a clock and for application to a specific telecommunication system that provides low data rate communication, low electric power consumption, and relatively small amounts of a data transmission unit for each time.

According to one aspect of the present invention, there is provided a clock correction circuit that comprises: a frequency data storage circuit for storing frequency set values corresponding to respective channels and outputting a frequency set value corresponding to a channel specified by a channel selection signal; a frequency correction circuit for calculating a frequency control value by performing a calculation using both the output frequency set value and a frequency correction value determined in accordance with an ambient temperature; a voltage controlled oscillator for generating a first frequency based on a clock signal; and a PLL circuit for generating a desired second frequency by performing a calculation using the first frequency and the frequency control value.

According to another aspect of the present invention, there is provided a communication apparatus that comprises: a frequency data storage circuit for storing frequency set values corresponding to respective channels and outputting a frequency set value corresponding to a channel specified by a channel selection signal; a frequency correction circuit for calculating a frequency control value by performing a calculation using both the output frequency set value and a frequency correction value determined in accordance with an ambient temperature; a voltage controlled oscillator for generating a first frequency based on a clock signal; a PLL circuit for generating a desired second frequency by performing a calculation using the first frequency and the frequency control value; and a transmitter and receiver circuit for transmitting or receiving data using the second frequency.

According to still another aspect of the present invention, there is provided a clock correcting method comprising the steps of: inputting a frequency correction value determined in accordance with an ambient temperature; generating a frequency set value corresponding to a channel to be used, on the basis of a plurality of frequency set values that are stored; performing a calculation using both the generated frequency set value and the frequency correction value to generate a frequency control value; generating a first frequency based on a clock signal that is inputted; and performing a calculation using both the first frequency and the frequency control value to generate a desired second frequency.

Further features of the invention, its nature and various advantages will be more apparent from the accompanying drawings and the following detailed description of the preferred embodiments.

### BRIEF DESCRIPTION OF THE DRAWINGS

FIG. 1 is a schematic diagram showing a radio communication system according to the present invention;

FIG. 2 is a block diagram showing a configuration of a base station and a terminal according to the present invention;

FIG. 3 is a block diagram showing a configuration of a transceiver circuit according to the present invention;

FIG. 4 is a block diagram showing a configuration of an RF circuit according to the present invention;

FIG. 5 is a block diagram showing a configuration of an RF control circuit of a first embodiment of the present invention;

FIG. 6 is a timing chart showing the operation of a channel decoder of the first embodiment;

FIG. 7 is a timing chart showing an operation of a transmission/reception switching circuit of the first embodiment;

FIG. 8 is a block diagram showing a configuration of a control circuit of the first embodiment;

FIG. 9 is a table showing a relationship between temperatures and their respective correction values according to the first embodiment;

FIG. 10 is a graph showing the relationship between the temperature and the frequency;

FIG. 11 is a block diagram showing a configuration of an RF control circuit of a second embodiment of the present invention;

FIG. 12 is a timing chart showing an operation of a channel decoder of the second embodiment;

FIG. 13 is a block diagram showing a configuration of a control circuit of the second embodiment;

FIG. 14 is a table showing a relationship between frequency shifts and their respective correction values according to the second embodiment; and

FIG. 15 is a block diagram showing a relationship between the temperature and frequency according to the second embodiment.

### DETAILED DESCRIPTION OF THE INVENTION

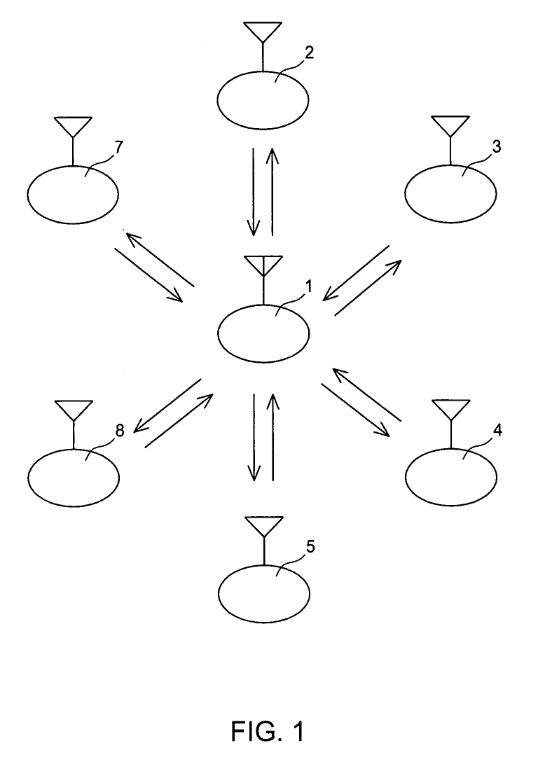

At the beginning, a radio communication system will be simply described. FIG. 1 is a schematic diagram showing a radio communication system. The radio communication system comprises a base station 1 and a plurality of terminals 2 to 7. Then, data is transmitted over the air from the base station 1 to the terminals 2 to 7, or from the terminals 2 to 7 to the base station 1.

Various embodiments according to the present invention will now be described with reference to the drawings.

### 1. First Embodiment

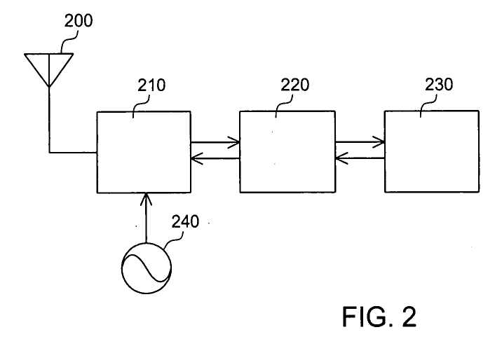

Each component and its operation in a communication apparatus of a first embodiment according to the present invention will de described with reference to the drawings. FIG. 2 is a block diagram showing a common configuration of the communication apparatus such as a base station, a fixed terminal or a mobile terminal which can be used in a radio communication system. The communication apparatus shown in FIG. 2 comprises an antenna 200, a transceiver circuit 210, a control circuit 220, a thermistor 230, and a reference clock generator 240.

The transceiver circuit 210 demodulates a reception signal and modulates a transmission signal. The control circuit 220 controls the transceiver circuit 210. The thermistor 230 measures an ambient temperature, and outputs the measurement result to the control circuit 220. The reference clock generator 240 supplies a clock signal required for operation of the transceiver circuit 210.

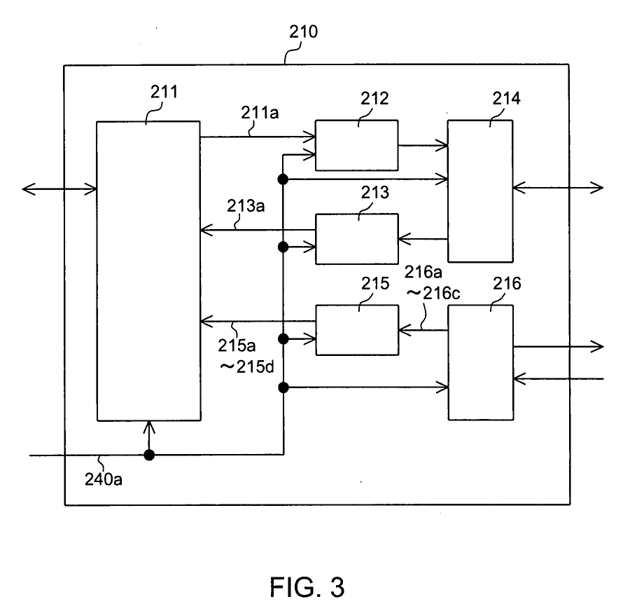

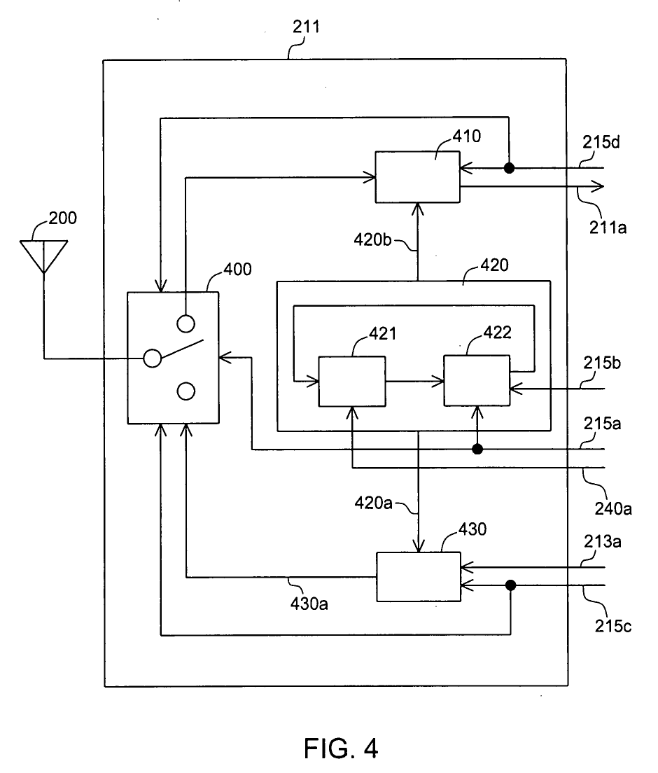

The transceiver circuit 210 will be described with reference to FIG. 3. FIG. 3 is a block diagram showing a configuration of the transceiver circuit 210 to be used in the embodiment according to the present invention. The transceiver circuit 210 comprises a RF circuit 211, a demodulator circuit 212, a modulator circuit 213, a data transceiver circuit 214, an RF control circuit 215, and a host interface 216.

The RF circuit 211 receives analog-modulated transmission data 213a from the modulator circuit 213, converts the data 213a into a harmonic signal, and outputs the harmonic signal to the antenna 200 during transmission. On the other hand, the RF circuit 211 receives a harmonic signal of reception data, converts the harmonic signal to a low-frequency signal, and outputs the low-frequency signal to the demodulator circuit 212 as reception data 211a during reception. The RF circuit 211 comprises a switch 400, a receiver circuit 410, a synthesizer 420, and a transmitter circuit 430. The switch 400 electrically connects the antenna 200 with the receiver circuit 410 during reception, and electrically connects the antenna 200 with the transmitter circuit 430 during transmission. The receiver circuit 400 receives reception data from the antenna 200, converts the received reception data to a low-frequency signal to generate reception data 211a during reception. The synthesizer 420 comprises a voltage controlled oscillator (VCO) 421, and Fractional-N type PLL circuit (hereinafter referred to as “PLL circuit”) 422. The VCO 421 receives a reference clock 240a output from the reference clock generator 240 to generate frequencies. The PLL circuit 422 performs a calculation of the following Equation (1) using a frequency control value 215b in response to a PLL enable signal 215a to generate harmonic clocks 420a, 420b:

$$Frf = \frac{Fset}{Fdiv} \times Forg , \qquad ( 1 )$$

where Frf represents the frequency of the harmonic clock 420a or 420b; Fset the frequency control value 215b; Fdiv a reference clock division value; and Forg the reference clock 240a, respectively. For example, when Fdiv=2¹⁷ and Forg=19.2 MHz, Equation (1) provides Frf=Fset×146.484 Hz, thus generating a desired frequency of about 150 Hz. The transmitter circuit 430 receives transmission data 213a from the modulator circuit 213, and converts the received transmission data 213a to a harmonic signal to generate transmission data transmitted from the antenna 200 during transmission. Operations of respective components in the RF circuit 211 will be described for transmission and reception individually.

### (1) During Transmission:

The VCO 421 of the synthesizer 420 generates a signal based on the reference clock 240a. The PLL circuit 422 of the synthesizer 420, upon receipt of the PLL enable signal 215a indicative of an enable state. In accordance with the frequency control value 215b, the PLL circuit 422 converts the signal generated by the VCO 421 to the harmonic clock 420a having a frequency required for transmission. Here, the signal generated with the reference clock 240a depends on the temperature and does not satisfy a standard specification of the radio system. The harmonic clock 420a is modified using the frequency control value 215b to satisfy the standard specification. The transmitter circuit 430, upon receipt of a transmission enable signal 215c indicative of an enable state, converts the transmission data 213a output from the modulator circuit 213 to harmonic transmission data 430a based on the harmonic clock 420a. Then, the switch 400 electrically connects the antenna 200 with the transmitter circuit 430 based on the PLL enable signal 215a and transmission enable signal 215c indicative of the enable states. Thus, the harmonic transmission data 430a is output through the antenna 200.

### (2) During Reception:

The VCO 421 of the synthesizer 420 generates a signal based on the reference clock 240a. The PLL circuit 422 of the synthesizer 420, upon receipt of a PLL enable signal 215a indicative of an enable state. The PLL circuit 422 converts the signal generated by the VCO 421 to the harmonic clock 420b having a frequency required for transmission, in accordance with the frequency control value 215b. Here, the signal generated with the reference clock 240a depends on the temperature, and does not satisfy the standard specification of the radio system. The harmonic clock 420b is modified using the frequency control value 215b to satisfy the standard specification. The switch 400 electrically connects the antenna 200 with the receiver circuit 410 based on the PLL enable signal 215a and reception enable signal 215b indicative of the enable states. Thus, harmonic reception data is received through the antenna 200. The receiver circuit 410, upon receipt of the reception enable signal 215d indicative of the enable state, converts the harmonic reception signal received by the antenna 200 to a low-frequency signal to generate a reception data signal 211a. The receiver circuit 410 outputs the reception data signal 211a to the demodulator circuit 212.

The demodulator circuit 212 converts the reception data 211a in analog form input from the RF circuit 211 to data in digital form during reception. The modulator circuit 213 converts transmission data in digital from input from the data transceiver circuit 214 to transmission data 213a in analog form during transmission. The data transceiver circuit 214 transfers transmission data input from the control circuit 220 to the converter circuit 213 during transmission, and transfers reception data input from the demodulator circuit 212 to the control circuit 220.

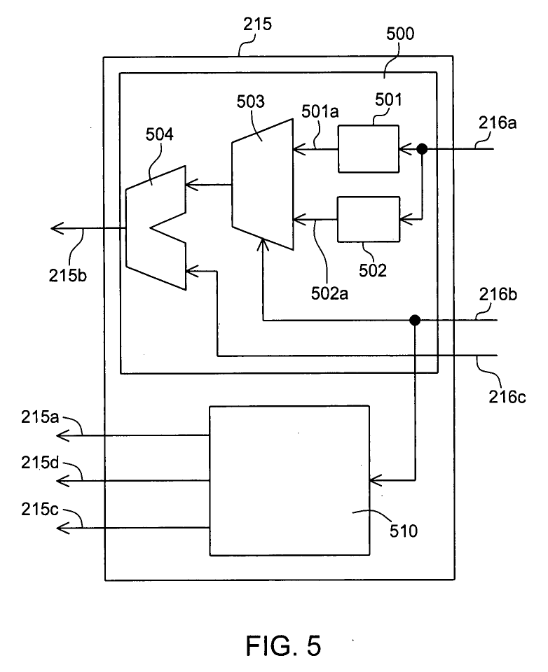

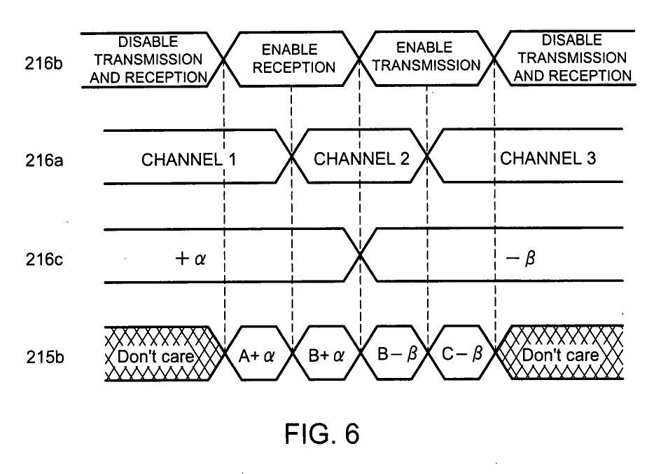

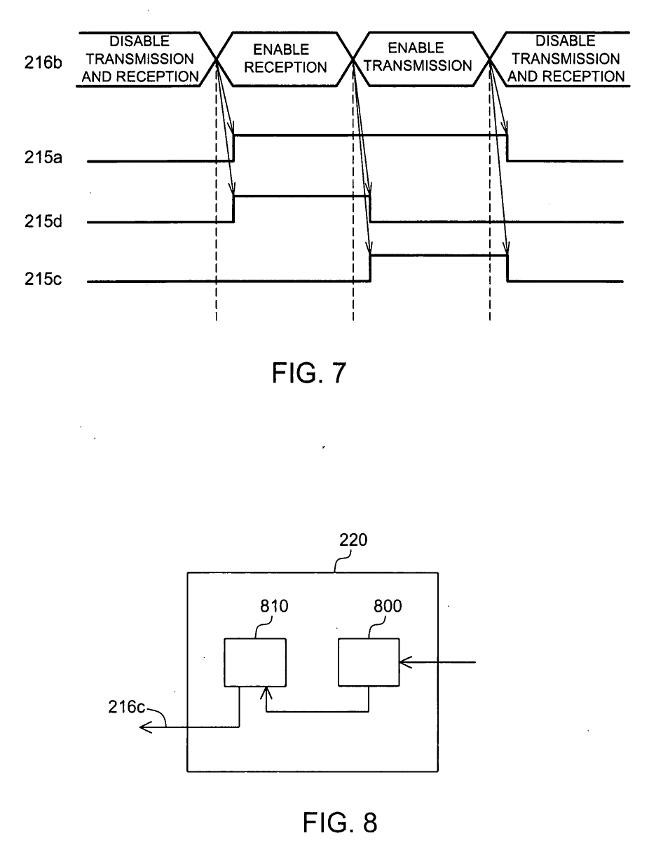

The RF control circuit 215 is a circuit for controlling the RF circuit 211, and generates the frequency control value 215b, PLL enable signal 215a, reception enable signal 215d, and transmission enable signal 215c. FIG. 5 is a block diagram showing the configuration of the RF control circuit 215. The RF control circuit 215 comprises a channel decoder 500 for generating the frequency control value 215b, and a transmission/reception switching circuit 510 for generating the PLL enable signal 215a, transmission enable signal 215c, and reception enable signal 215d. The channel decoder 500 comprises a reception frequency set value storage circuit 501, a transmission frequency set value storage circuit 502, a selector 503, and a frequency correction circuit 504. The reception frequency set value storage circuit 501 stores frequency set values on a channel-by-channel basis during reception. The reception frequency set value storage circuit 501 outputs a frequency set value 501a corresponding to a channel specified by a channel selection signal 216a from among a plurality of frequency set values stored therein. The transmission frequency set value storage circuit 502 stores frequency set values on a channel-by-channel basis during transmission. The transmission frequency set value storage circuit 502 outputs a frequency set value 502a corresponding to a channel specified by the channel selection signal 216a from among a plurality of frequency set values stored therein. The selector 503 selects and outputs one of the frequency set value 501a output from the reception frequency set value storage circuit 501 or the frequency set value 502a output from the transmission frequency set value storage circuit 502 in accordance with a transmission/reception switching signal 216b. The frequency correction circuit 504 adds or subtracts frequency correction information 216c to or from the frequency set value selected by the selector 503 to output the frequency control value 215b. The transmission/reception switching circuit 510 generates the PLL enable signal 215a, transmission enable signal 215c, and reception enable signal 215d in accordance with a transmission/reception switching signal 216b applied thereto. The operation of the RF control circuit 215 will be described below with reference to FIGS. 6 and 7. FIG. 6 is a timing chart showing the operation of the channel decoder 500. FIG. 7 is a timing chart showing the operation of the transmission/reception switching circuit 510.

First, the operation of the channel decoder 500 will be described with reference to FIG. 6. For describing the operation in a readily understandable manner, assume that the transmission/reception switching signal 216b operates to “disable transmission and reception,” “enable reception,” “enable transmission,” and “disable transmission and reception” in this order. When the transmission/reception switching signal 216b indicates a transmission/reception disabling state, the frequency control value 215b is not at all affected. Next, when the transmission/reception switching signal 216b indicates a reception enabling state, the channel selection signal 216a indicates Channel 1, and the frequency correction information 216c indicates +α, the channel decoder 500 outputs a frequency control value 215b indicative of the sum A+α of a frequency set value A stored in Channel 1 of the transmission frequency set value storage circuit 501 and the frequency correction information +α. Next, when the transmission/reception switching signal 216b indicates the reception enabling state, the channel selection signal 216a indicates Channel 2, and the frequency correction information 216c indicates +α, the channel decoder 500 outputs a frequency control value 215b indicative of the sum B+α of a frequency set value B stored in Channel 2 of the reception frequency set value storage circuit 501 and frequency correction information +α. Next, when the transmission/reception switching signal 216b indicates a transmission enabling state, the channel selection signal 216a indicates Channel 2, and the frequency correction information 216c indicates −β, the channel decoder 500 outputs a frequency control value 215b indicative of the difference B−β between the frequency set value B stored in Channel 2 of the transmission frequency set value storage circuit 502 and the frequency correction information −β. Next, when the transmission/reception switching signal 216b indicates the transmission enabling state, the channel selection signal 216a indicates Channel 3, and the frequency correction information 216c indicates −β, the channel decoder 500 outputs a frequency control value 215b indicative of the difference C−β between a frequency set value C stored in Channel 3 of the transmission frequency set value storage circuit 502 and the frequency correction information −β.

Next, the operation of the transmission/reception switching circuit 510 will be described with reference to FIG. 7. For describing the operation in a readily understandable manner, assume that the transmission/reception switching signal 216b operates to “disable transmission and reception,” “enable reception,” “enable transmission,” and “disable transmission and reception” in this order. The state represented by the PLL enable signal 215a transitions to an enabling state (which indicates herein a state in which the voltage level is at H level, which is applied to the following description) when the state represented by the transmission/reception switching signal 216b transitions from the “transmission/reception disabling state” to the “reception enabling state.” The PLL enable signal 215a remains in the enable state until the state represented by the transmission/reception switching signal 216b transitions to the “transmission/reception disabling state.” The state represented by the reception enable signal 215d transitions to an enabling state when the state represented by the transmission/reception switching signal 216b transitions to the “reception enabling state.” Here, the state represented by the reception enable signal 215d transitions to a disabling state (which indicates herein a state in which the voltage level is at L level, which is applied to the following description) when the state represented by the transmission/reception switching signal 216b transitions from the “reception enabling state” to the “transmission enabling state.” Stated another way, the reception enable signal 215d goes to the enable state in synchronism with a transition of the transmission/reception switching signal 216b to the “reception enabling state.” The state represented by the transmission enable signal 215c transitions to the enabling state when the state represented by the transmission/reception switching signal 216b transitions to the “transmission enabling state.” Here, the state represented by the transmission enable signal 215c transitions to a disabling state when the state represented by the transmission/reception switching signal 216b transitions from the “transmission enabling state” to the “transmission/reception disabling state.” Stated another way, the transmission enable signal 215c goes to the enable state in synchronism with a transition of the transmission/reception switching signal 216b to the “transmission enabling state.”

The host interface 216 transmits and receive data of instruction type other than transmission/reception data between the control circuit 220 and the transceiver circuit 210, and holds instruction. Upon receipt of a transmission instruction, a reception instruction, an RF channel setting instruction or the like from the control circuit 20, the host interface 216 transfers the instruction to the RF control circuit 215.

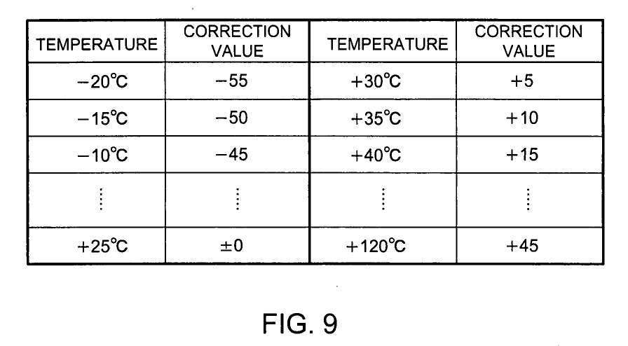

Next, the control circuit 220 will be described with reference to FIGS. 8 and 9. FIG. 8 is a block diagram showing the configuration of the control circuit 220. FIG. 9 is a table showing the relationship between the temperature and correction values. Here, the control circuit 220 comprises an address generator circuit 800 and a temperature correction value storage circuit 810. Upon receipt of information indicative of the ambient temperature detected by the thermistor 230, the address generator circuit 800 generates an address corresponding to the information which is output to the temperature correction value storage circuit 810. A shown in FIG. 9, the temperature correction value storage circuit 810 stores correction values for variations in temperature in a tabular form. The temperature and correction values are stored in a one-to-one correspondence. For example, the correction value is −45 when the measured temperature is 20° C., and the correction value is +45 when the measured temperature is 120° C. In this connection, the correction values depends on particular specifications, and those listed in the table do not indicate all corrections. Upon receipt of the address output from the address generator circuit 800, the temperature correction value storage circuit 810 outputs a correction value corresponding to the address from a plurality of correction values stored therein as the frequency correction information 216c.

Next, the thermistor 230 will be described. The thermistor 230 is a resistor which exhibits a large change in electric resistance to variations in temperature. Though depending on specifications, the thermistor can measures temperatures approximately from −50° C. to 350° C. The thermistor 230 measures the ambient temperature around a base station or a terminal and outputs the result of the measurement to the control circuit 220.

Next, the reference clock generator 240 will be described. The reference clock generator 240 of this embodiment is not an expensive clock generator which does not depend on variations in temperature, but an inexpensive clock generator which depends on variations in temperature. The reference clock generator 240 generates a reference clock which is affected by variations in the ambient temperature, and supplies the reference clock to the transceiver circuit 210.

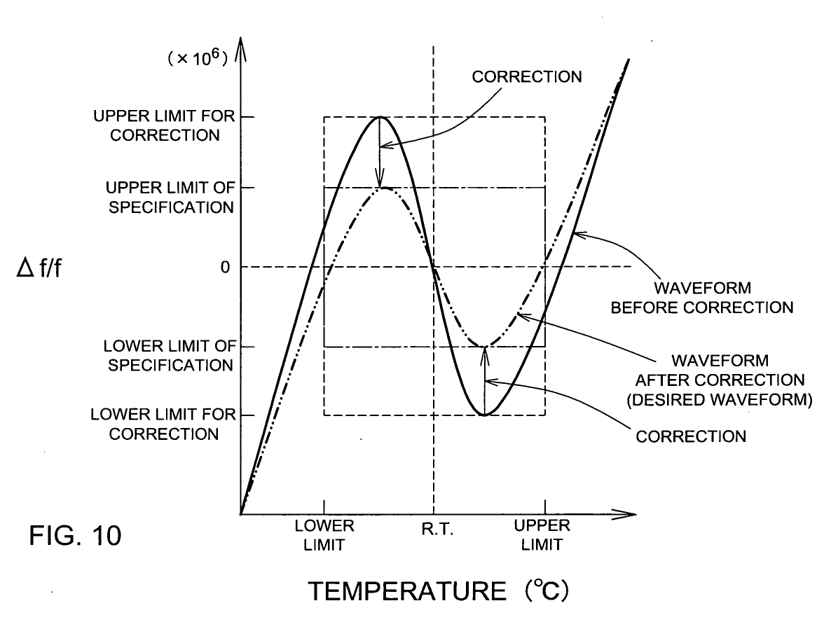

Next, the general operation of the communication apparatus of the first embodiment will be described with reference to FIG. 10. FIG. 10 is a graph showing the relationship between the temperature and frequency, where a solid line indicates a signal before a correction, and a broken line indicates a signal after the correction. The reference clock generator 240 supplies the reference clock 240a which varies in response to a change in temperature to the transceiver circuit 210 and control circuit 220. The thermistor 230 measures the ambient temperature, and outputs the measurement result 230a to the control circuit 220. Upon receipt of the measurement result 230a, the control circuit 220 generates an address corresponding thereto, and outputs the frequency correction information 216c corresponding to the address. The transceiver circuit 210 adds or subtracts the frequency correction information 216c to or from a stored frequency set value to generate the frequency control value 215b. The transceiver circuit 210 corrects the frequency of a signal (solid line in FIG. 10) generated on the basis of the clock signal 240a using the frequency control value 215b to generate a signal (broken line in FIG. 10) having a frequency which meets the standard specification.

As described above, according to the communication apparatus of the first embodiment, it is possible to generate a signal which meets the standard specification, similar to a signal generated using an expensive clock generator, even if an inexpensive clock generator is used. Thus, according to the communication apparatus of the first embodiment it is possible to provide an inexpensive system, apparatus and the like which can reduce the cost of the communication system or the overall apparatus.

Also, according to the communication apparatus of the first embodiment, each user can freely set the frequency correction information for the temperature which has been conventionally fixed as the performance of a clock generator. Thus, according to the communication apparatus of the first embodiment, it is possible to provide a communication system which can accommodate different needs on a user-by-user basis.

Also, according to the communication apparatus of the first embodiment, since each user can freely sets the frequency correction information for the temperature, the frequency correction information can be set in consideration of an actual use environment. Thus, according to the communication apparatus of the first embodiment, a stable communication system can be provided.

### 2. Second Embodiment

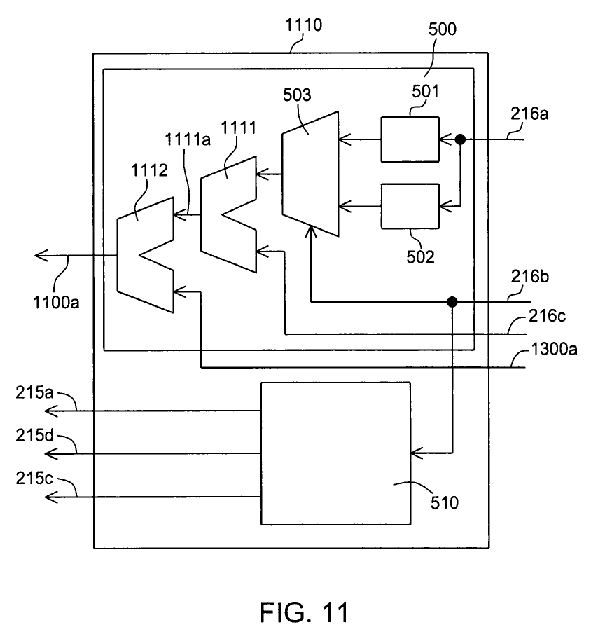

In the following, a communication apparatus of a second embodiment according to the present invention will be described with reference to the drawings. In regard to the same configuration and operation as the communication apparatus of the first embodiment described above, a description thereon is omitted. FIG. 11 is a block diagram showing the configuration of an RF control circuit 10 of the second embodiment. The RF control circuit 1100 comprises a channel decoder 1110 for generating a frequency control value 1100a which is applied to a PLL circuit 422 of a synthesizer 420, and a transmission/reception switching circuit 510.

The channel decoder 110 comprises a reception frequency set value storage circuit 501, a transmission frequency set value storage circuit 502, a selector 503, and frequency correction circuits 1111, 1112. The frequency correction circuit 1111 adds or subtracts frequency correction information 216c to or from a frequency set value selected by the selector 503 to output a frequency set value 1111a. The frequency correction circuit 1111 adds or subtracts center frequency correction information 1300 to or from the frequency set value 1111a to output a frequency control value 1100a.

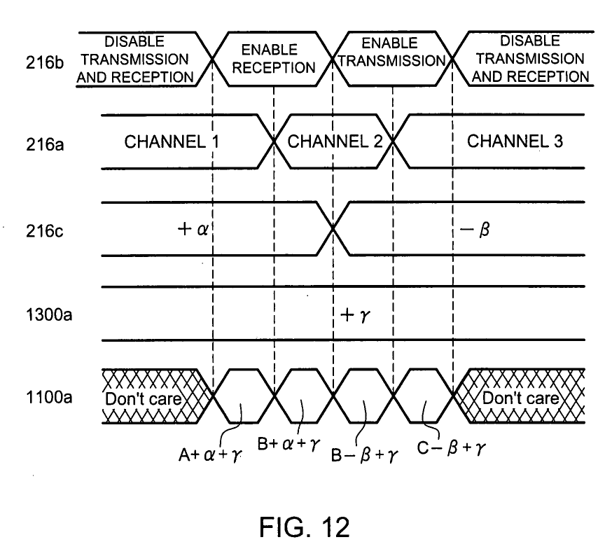

The operation of the channel decoder 1110 will be described with reference to FIG. 12. FIG. 12 is a timing chart showing the operation of the channel decoder 1100. For describing the operation in a readily understandable manner, assume that the transmission/reception switching signal 216b operates to “disable transmission and reception,” “enable reception,” “enable transmission,” and “disable transmission and reception” in this order. When the transmission/reception switching signal 216b indicates a transmission/reception disabling state, the frequency control value 1100a is not at all affected. Next, when the transmission/reception switching signal 216b indicates a reception enabling state, the channel selection signal 216a indicates Channel 1, and the frequency correction information 216c indicates +α, and the center frequency correction information 1300a indicates +γ, the channel decoder 1110 outputs a frequency control value 1100a indicative of the sum A+α+γ of a frequency set value A stored in Channel 1 of the reception frequency set value storage circuit 501, the frequency correction information +α, and center frequency correction information +γ. Next, when the transmission/reception switching signal 216b indicates the reception enabling state, the channel selection signal 216a indicates Channel 2, and the frequency correction information 216c indicates +α, and the center frequency correction information 1300a indicates +γ, the channel decoder 1110 outputs a frequency control value 1100a indicative of the sum B+α+γ of a frequency set value B stored in Channel 2 of the reception frequency set value storage circuit 501, the frequency correction information +α, and center frequency correction information +γ. Next, when the transmission/reception switching signal 216b indicates a transmission enabling state, the channel selection signal 216a indicates Channel 2, and the frequency correction information 216c indicates −β, and the center frequency correction information 1300a indicates +γ, the channel decoder 1110 outputs a frequency control value 1100a indicative of a calculation result B−β+γ of a frequency set value B stored in Channel 2 of the reception frequency set value storage circuit 501, the frequency correction information −β, and center frequency correction information +γ. Next, when the transmission/reception switching signal 216b indicates the transmission enabling state, the channel selection signal 216a indicates Channel 3, and the frequency correction information 216c indicates −β, and the center frequency correction information 1300a indicates +γ, the channel decoder 1110 outputs a frequency control value 1100a indicative of a calculation result C−β+γ of a frequency set value C stored in Channel 2 of the reception frequency set value storage circuit 501, the frequency correction information −β, and center frequency correction information +γ.

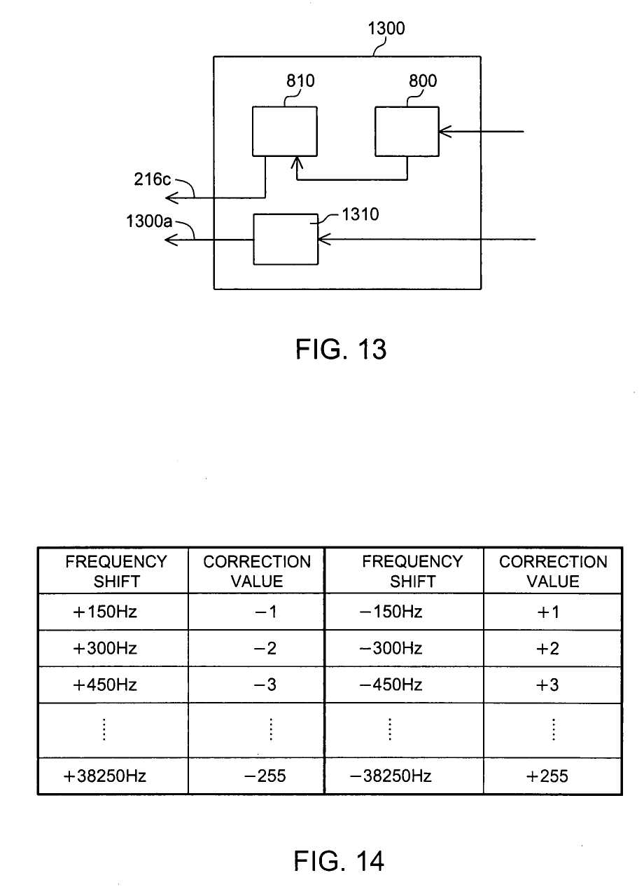

Next, a control circuit 1300 will be described with reference to FIGS. 13 and 14. FIG. 13 is a block diagram showing the configuration of the control circuit 1300. FIG. 14 is a table showing the relationship between frequency shifts and their respective correction values. Here, the control circuit 1300 comprises an address generator circuit 800, a temperature correction value storage circuit 810, and center frequency correction value storage circuit 1310. The center frequency correction value storage circuit 1310 stores correction values corresponding to their respective frequency shifts in a tabular form as shown in FIG. 14. The frequency shifts and correction values are stored in a one-to-one correspondence. For example, the correction value is −1 when the frequency shift is +150 Hz, and the correction value is +255 when the frequency shift is −38250 Hz. In this connection, the correction values depends on particular specifications, and those listed in the table do not indicate all corrections. Upon receipt of center frequency shift information, the center frequency correction value storage circuit 1310 outputs a correction value corresponding to the shift from a plurality of correction values stored therein as the center frequency correction information 1300a.

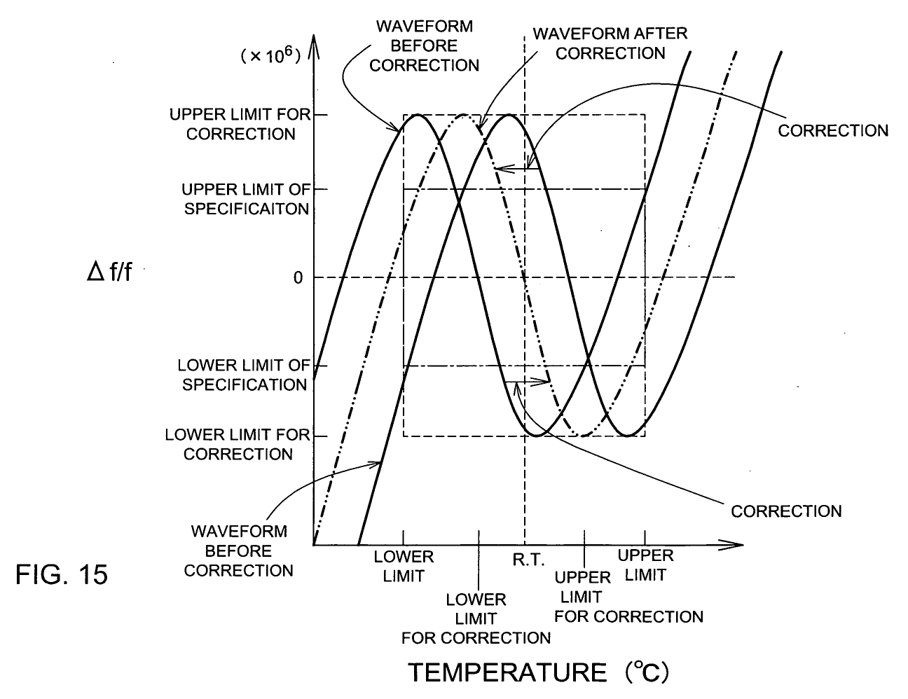

Next, the general operation of the second embodiment will be described with reference to FIG. 15. FIG. 15 is a graph showing the relationship between the temperature and frequency, where a solid line indicates a signal before a correction, and a broken line indicates a signal after the correction. The reference clock generator 240 supplies the reference clock 240a which varies in response to a change in temperature to the transceiver circuit 210 and control circuit 1300. The thermistor 230 measures the ambient temperature, and outputs the measurement result 230a to the control circuit 1300. Upon receipt of the measurement result 230a, the control circuit 1300 generates an address corresponding thereto, and outputs the frequency correction information 216c corresponding to the address. Upon receipt of the center frequency shift information, the control circuit 1300 outputs a correction value corresponding to the shift from a plurality of correction values stored therein as the center frequency correction information 1300a. The transceiver circuit 210 adds or subtracts the frequency correction information 216c and center frequency correction information 1300a to or from a stored frequency set value to generate the frequency control value 1100a. The transceiver circuit 210 corrects the frequency of a signal (solid line in FIG. 15) generated on the basis of the clock signal 240a using the frequency control value 1100a to generate a signal (broken line in FIG. 15) having a frequency which meets the standard specification.

As described above, the communication apparatus of the second embodiment has the same advantages as the apparatus of the first embodiment. Further, according to the communication apparatus of the second embodiment, it is possible to correct the center frequency for its shift, thereby correcting for frequency shifts occurring during the manufacturing even if an expensive reference clock generator is used.

Additionally, according to the communication apparatus of the second embodiment, the frequency shift can be freely corrected after a field test has been conducted, by the correction of the center frequency for its shift.

This application is based on Japanese patent application No. 2006-062939, and claims the benefit thereof. The Japanese patent application is hereby incorporated by reference.

What is claimed is:

1. A clock correction circuit comprising:
a frequency data storage circuit for storing frequency set values corresponding to respective channels and outputting a frequency set value corresponding to a channel specified by a channel selection signal;
a frequency correction circuit for calculating a frequency control value by performing a calculation using both the output frequency set value and a frequency correction value determined in accordance with an ambient temperature;
a voltage controlled oscillator for generating a first frequency based on a clock signal; and
a PLL circuit for generating a desired second frequency by performing a calculation using the first frequency and the frequency control value.

2. A clock correction circuit according to claim 1, further comprising:
a reference clock generator for generating a reference clock as the clock signal; and
a control circuit for storing frequency correction values corresponding to respective temperatures and outputting the frequency correction value corresponding to a detected ambient temperature.

3. A clock correction circuit according to claim 1, further comprising a thermistor for measuring the ambient temperature as the detected ambient temperature.

4. A clock correction circuit according to claim 1, wherein said frequency correction circuit calculates the frequency control value using a center frequency correction value together with the output frequency set value and the frequency correction value.

5. A communication apparatus comprising:
a frequency data storage circuit for storing frequency set values corresponding to respective channels and outputting a frequency set value corresponding to a channel specified by a channel selection signal;
a frequency correction circuit for calculating a frequency control value by performing a calculation using both the output frequency set value and a frequency correction value determined in accordance with an ambient temperature;
a voltage controlled oscillator for generating a first frequency based on a clock signal;
a PLL circuit for generating a desired second frequency by performing a calculation using the first frequency and the frequency control value; and
a transmitter and receiver circuit for transmitting or receiving data using the second frequency.

6. A communication apparatus according to claim 5, further comprising:
a reference clock generator for generating a reference clock as the clock signal; and
a control circuit for storing frequency correction values corresponding to respective temperatures and outputting the frequency correction value corresponding to a detected ambient temperature.

7. A communication apparatus according to claim 6, further comprising a thermistor for measuring the ambient temperature as the detected ambient temperature.

8. A communication apparatus according to claim 5, wherein said frequency correction circuit calculates the frequency control value using a center frequency correction value together with the output frequency set value and the frequency correction value.

9. A clock correcting method comprising the steps of:
inputting a frequency correction value determined in accordance with an ambient temperature;
generating a frequency set value corresponding to a channel to be used, on the basis of a plurality of frequency set values that are stored;
performing a calculation using both the generated frequency set value and the frequency correction value to generate a frequency control value;
generating a first frequency based on a clock signal that is inputted; and
performing a calculation using both the first frequency and the frequency control value to generate a desired second frequency.

10. A clock correction method according to claim 9, further comprising the steps of:
generating a reference clock as the clock signal; and
reading out the frequency correction value corresponding to a detected ambient temperature from a storage memory that stores frequency correction values corresponding to respective temperatures.

11. A clock correction method according to claim 10, further comprising the step of measuring the ambient temperature as the detected ambient temperature.
